(19) United States
(12) Patent Application Publication
(10) Pub. No.: US 2008/0074796 A1
(43) Pub. Date: Mar. 27, 2008

(54) Ramp load/unload mechanism and storage device

(75) Inventor: Satoru Shimizu, Kawasaki (JP)

Correspondence Address: Patrick G. Burns;GREER, BURNS & CRAIN, LTD., Suite 2500, 300 South Wacker Drive, Chicago, IL, 60606, US

(73) Assignee: FUJITSU LIMITED

(21) Appl. No.: 11/726,004

(22) Filed: Mar. 20, 2007

(30) Foreign Application Priority Data
Sep. 27, 2006 (JP) 2006-263063

(51) Int. Cl. G11B 5/54

(52) U.S. Cl. 360/254.7

(57) ABSTRACT

A ramp mechanism for a storage device reduces power consumption during head loading/unloading operations, and reduces magnetic disk drive failure due to generation and dispersion of wear powder generated by head loading and unloading operations. Wear powder is accumulated in longitudinal grooves in the ramp mechanism. A lateral groove can be provided at the head entry/exit end of the ramo mechanism to capture wear powder, if desired. The grooves are separated by wall parts having flat, tip-shaped or semi-circularly shaped tops, and the tops can extend partially over the grooves, if desired, to trap powder which falls into the grooves.

### FIELD OF THE INVENTION

The present invention relates to a storage device and a ramp load/unload mechanism for heads, and more particularly to a load/unload system that reduces and better controls dispersion of wear powder generated by loading and unloading operations.

### BACKGROUND OF THE INVENTION

In recent years, requirements for improvement in the capacity of storage devices have grown rapidly. One way larger capacity has been realized is by reducing the distance between a storage medium for storing data and a head slider for reading and writing the data, and using a load/unload system to withdraw and park the head slider to a predetermined resting position outside the area of the storage medium when not in use, so as to avoid unwanted contact with the medium.

Modern magnetic disk drives have reduced size and increased storage capacity. As a result, such magnetic disk drives have been used not only in stationary information processing apparatuses which are installed within a room, but also in various portable type apparatuses such as a notebook size personal computer and a portable terminal.

Particularly in such portable equipment, it is preferable to withdraw the head from the area on the storage medium for resisting the shock generated by vibration and dropping. Accordingly, the load/unload system has often been used.

However, in known load/unload systems, wear powder or dust is generated during the loading and unloading operations. If wear powder lands on a storage medium during the loading period and is adhered to a head slider moving on the disk, premature head or other failure can occur before the end of the expected useful life of the disk drive.

Moreover, if a head fails, access to a storage medium on which data is stored is disabled and thereby data is lost, probably resulting in a large adverse effect on system operation or the like in which a magnetic disk drive is used.

Accordingly, a variety of techniques have been proposed for preventing failures of the magnetic disk drive due to wear powder.

According to Japanese Unexamined Patent Publication No. 2003-141841, ramp contact points of a head tab are equally distributed in the longitudinal direction by continuously changing a shape of the cross-section of the ramp running plane. As a result, random wear of the head tab is not generated, avoiding an increase in sliding resistance. However, a failure is likely generated in the magnetic disk drive, because wear powder is still generated and it is difficult to sufficiently prevent the dropping of such wear powder on the storage medium.

According to Japanese Unexamined Patent Publication No. 2003-568657, deposition of wear powder on a head suspension can be prevented by changing a contact position with the sliding part on the head suspension. As a result, deposition of wear powder on the head suspension is distributed in the longitudinal direction and thereby wear powder is not as easily dropped because it does not aggregate. Moreover, wear powder drops to a recessed area of the sliding part, so it is less easily dropped on the storage medium.

However, in the case where a projected area is provided almost perpendicular to the sliding direction of the head suspension, the projected area works as a barrier and causes an increase of resistance. Therefore, power consumption of the magnetic disk drive increases. That is, a resistance force is generated when the head suspension collides with the projected area or rides over the projected area during the sliding operation thereof. Accordingly, power consumption increases because extra power is required to overcome such resistance force.

Increase of power consumption results in a serious problem in a portable device, for example, particularly a notebook size personal computer and a portable terminal which are operated by a built-in power supply such as a battery.

Moreover, in the case of a notebook size personal computer, the orientation of the personal computer is often changed when it is used (operated) and when it is placed in a bag and carried. The orientation of the magnetic disk drive is also changed according to the attitude of the personal computer.

Therefore, wear powder which has been once dropped on the groove part can then be scattered into the casing if the orientation of the personal computer is changed, as explained above, or with an external factor such as external vibration and shock. Accordingly, if the wear powder which is once scattered drops on the storage medium, an earlier failure, namely, a magnetic disk drive failure is generated. Therefore, a significant adverse consequence such as destruction of data is likely.

Accordingly, one object of the present invention is to prevent premature head failure, that is, a failure in the magnetic disk drive before the end of its useful life. Another object is to reduce power consumption of a magnetic disk drive by lowering the resistance resulting from the sliding operation of the heads in loading/unloading operations.

### SUMMARY OF THE INVENTION

In keeping with one aspect of this invention, a first groove part formed of a plurality of groove portions is provided along the longitudinal direction of a generally rectangle sliding part for accumulating wear powder generated by sliding which occurs during load/unload operations. A second groove part can be provided along the short-side direction of the sliding part to prevent drop of the wear powder to the sliding part of a ramp mechanism.

The first groove part can be oriented almost parallel to the sliding direction of the head suspension. The first groove part can include a scatter preventing part extending a predetermined distance toward the center of the groove portions in the short-side direction, to trap wear powder which falls in the groove portions.

### BRIEF DESCRIPTION OF THE DRAWINGS

The above mentioned and other features of this invention and the manner of obtaining them will become more apparent, and the invention itself will be best understood by reference to the following description of an embodiment of the invention taken in conjunction with the accompanying drawings, in which:

FIG. 1 is a schematic diagram of a magnetic disk drive having the ramp mechanism of the present invention.

FIG. 2A is a perspective view of the ramp member of the present invention, FIG. 2B is an enlarged view of a sliding part of the ramp member of FIG. 2A, and FIG. 2C is a cross-sectional view taken along lines A-A′ in FIG. 2A.

FIG. 3 is an operating diagram of load tab movement on the sliding part pf the ramp mechanism of FIG. 1.

FIGS. 4A-4C are cross-sectional views of the sliding part in a first embodiment.

FIGS. 5A-5C are cross-sectional views of the sliding part in a second embodiment.

### DETAILED DESCRIPTION

A magnetic disk drive in relation to a first embodiment of the present invention will be explained with reference to the accompanying drawings.

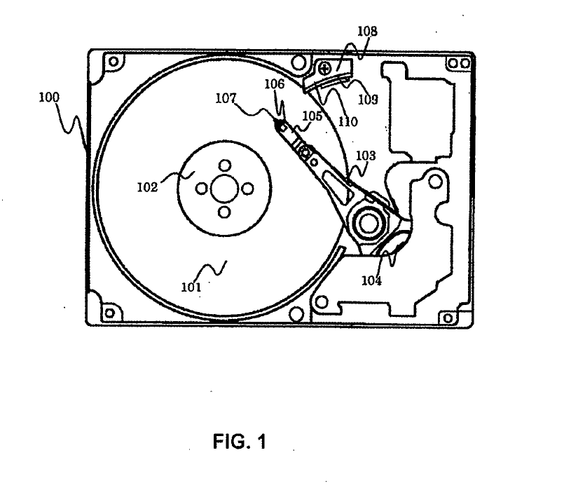

FIG. 1 is a schematic diagram of a magnetic disk drive. Various structural members of the magnetic disk drive are accommodated within an almost rectangular-parallelepiped casing 100. The inside of the casing is hermetically sealed and protected from dust with a cover (not shown) coupled with the casing 100.

Reference numeral 101 denotes a storage medium for storing data, which is rotationally operated by a spindle motor 102. An actuator mechanism 103 is coupled with a pivot extending in the vertical direction to conduct rotational operation controlled by a voice coil motor 104 around the pivot.

The actuator mechanism 103 is coupled with a head suspension mechanism 105 at the end part thereof and a magnetic head slider 106 is pivotally supported at the area near the end part of the head suspension mechanism 105. The head suspension mechanism 105 supports the magnetic head slider 106 and generates a predetermined force for pressing the magnetic head suspension 105 toward the storage medium.

In addition, a load tab 107 extends forward from the end part thereof at the end part of the head suspension mechanism 105 in order to moor the magnetic head slider 106 to a ramp mechanism 108 arranged at the circumferential edge of the magnetic disk drive.

The ramp mechanism 108 is mounted, in the casing 100, for example, using screws, and includes a mooring part 109 for mooring the magnetic head slider 106 to the predetermined position via the load tab 107 and a sliding part 110 for sliding on the load tab 107 when the magnetic head slider is drawn toward the mooring part 109 from the area above the storage medium.

The ramp mechanism 108 may be provided with a plurality of mooring portions 109 and sliding portions 110 to accommodate the number of magnetic head sliders 106 in the magnetic disk drive. The ramp mechanism 108 may be manufactured, for example, by a molding process using hard plastic material and resin material molded in metal dies.

A load/unload mechanism is structured with the ramp mechanism 108 and load tab 107, and load/unload operations will be explained generally on the basis of the operations of the magnetic disk drive.

When a power supply switch of the magnetic disk drive 100 is turned ON and the storage medium 101 rotates with operation of the spindle motor 102, air-flow is generated at the surface of the storage medium 101. Thereafter, when the actuator mechanism 103 rotates around the pivot due to the operation of the voice coil motor 104, the load tab 107 starts to move from the mooring part 109 on the ramp mechanism 108 and conducts the sliding operation at the sliding part 110. As a result, the magnetic slider 106 moored by the ramp mechanism 108 via the load tab 107 is loaded on the storage medium 101 (loading operation).

When the magnetic head slider 106 is loaded over the medium, a positive pressure, namely a floating force and a negative force are applied to the magnetic head slider 106 due to the effect of air-flow explained above. When the floating force, a negative pressure, and a pressing force of the head suspension mechanism 105 are balanced, the magnetic head slider 106 can be floated with a comparatively higher rigidity during rotation of the storage medium 101.

When the actuator mechanism 103 further continues the rotating operation thereof, it rotates on the storage medium 101 of the magnetic head slider 106. A head element part (not illustrated) provided to the magnetic head slider is positioned to predetermined locations to execute read/write operations of data.

Meanwhile, the magnetic head slider 106 is unloaded toward the ramp mechanism 108 from the area on the storage medium 101 when read/write processes are completed by the head element part or operation of the magnetic disk drive is completed (withdrawing operation).

Namely, when the magnetic head slider 106 is unloaded from the storage medium 101 with the rotating operation of the actuator mechanism 103, the load tab 107 is placed in contact with the sliding part 110 of the ramp mechanism 108 and moves toward the mooring part 109 by continuing the sliding operation.

The actuator mechanism 103 stops operation when it reaches the predetermined position of the mooring part 109 and the magnetic head slider 106 is moored again at the predetermined position. The loading operation is conducted on the basis of almost the reverse flow of the unloading operation explained above.

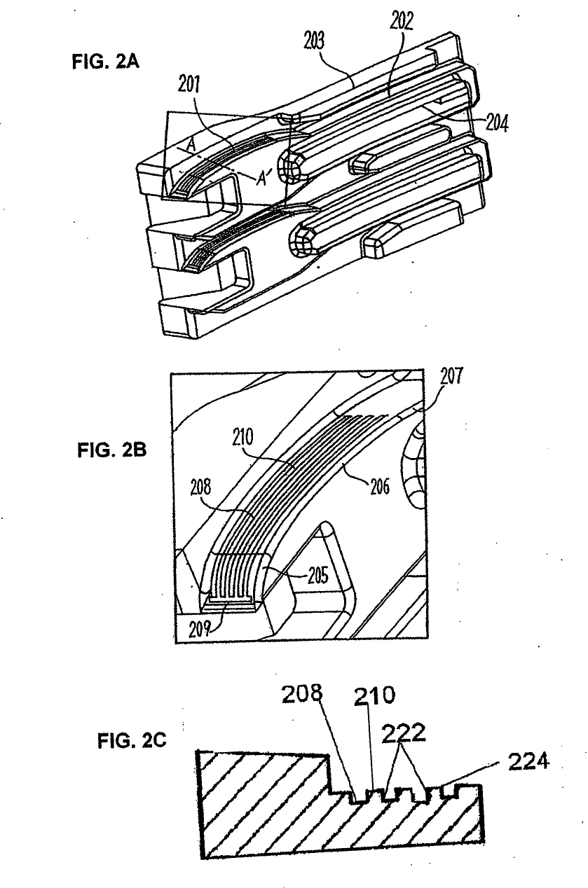

The ramp mechanism in relation to the first embodiment of the present invention will be explained on the basis of FIG. 2A-FIG. 2C.

A sliding part 201 is formed generally in a trapezoidal shape, and includes an incoming part 205, a parallel moving part 206 and an outgoing part 207.

The incoming part 205 is placed first in contact with the load tab 107 during the unloading operation and a first groove part constituted with a plurality of groove portions 208 along the longitudinal direction of the sliding part is formed on the surface of the incoming part 205 in order to accumulate wear powder.

Moreover, a second groove part 209 of a generally rectangular shape has a longer side in the short-side or lateral direction of the sliding part in order to connect each end part of the first groove part 208 explained above at the location separated by the predetermined distance from the end part of the incoming part 205. Thereby, drop of wear powder on the storage medium 101 can be better prevented. The depth of the second groove part 209 is almost equal to that of the first groove part 208.

The parallel moving part 206 is formed higher than the rotating orbit plane of the head suspension mechanism 105 on the storage medium 101 and is placed in contact with the load tab 107 due to the predetermined elasticity of the load tab 107. In addition, the groove part is also defined in continuation from the first groove part of the incoming part 205 at the surface of the parallel moving part 206. Therefore, wear powder generated when the load tab 107 slides on the wall part 210 defining the first groove part 208 as in the case of incoming part 205 drops and is accumulated within the first groove part 208 like the wear powder generated at the incoming part 205.

The outgoing part 207 has a predetermined inclination to guide the load tab 107 to the mooring part 109 from the parallel moving part 206. It is also possible to provide the first groove part continued from the parallel moving part in this outgoing part 207 but it is not always required because the wear powder is expected to drop in the first groove part 208 provided to the parallel moving part 206 during the loading operation.

The mooring part 202 has a flat surface formed in height almost equal to the rotating surface of the head suspension mechanism 105. This part does not apply a load to the magnetic head slider 105 or the like being moored.

Moreover, a first guide part 203 is provided on the mooring part 202 so as to not allow the load tab 107 to move from the mooring part even when an external shock is applied thereto.

A second guide part 204 is provided to prevent each magnetic head slider 106 from colliding with another slider 106 even when a plurality of magnetic head sliders 106 are moored.

As seen in FIG. 2C, the groove parts 208 are separated by the wall parts 210. Each groove 208 is formed by two opposed side walls 222. Each wall part 210 has a top 224, which is flat in FIG. 2C.

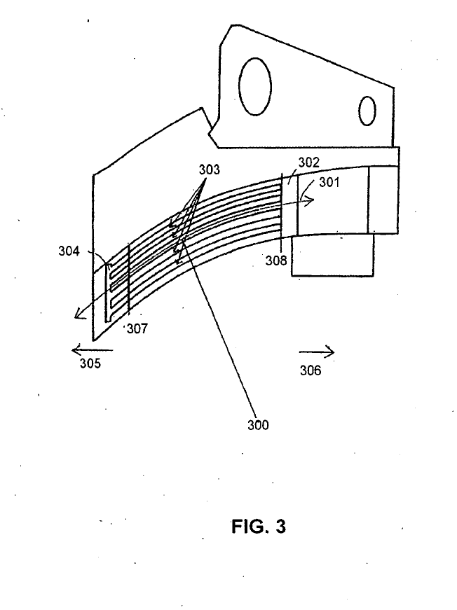

Operations of the load tab 107 and the sliding part during unloading and loading periods will be explained in detail with reference to a plan view of the sliding part shown in FIG. 3.

The ramp mechanism used in this embodiment is curved with inclusion of an internal arc in the side of a rotating axis 300 of the suspension. A first groove part is formed at the sliding part along the internal arc of the ramp mechanism, almost parallel to the sliding direction of the load tab 107.

The load tab 107 unloading from the area on the storage medium 101 moves on a sliding part 302 while drawing an arc along the orbit 301 in contact with the incoming part 205 (up to a straight line 307 from a side end 305) having a predetermined inclination angle at the upper side of a second groove part 304. Thereafter, wear powder is generated when the load tab 107 moves upward on the slope of the incoming part 205.

Wear powder is also generated because the sliding operation is conducted through contact under a constant elasticity during the sliding operation at the parallel moving part 206 (up to the straight line from a line 307).

According to this first embodiment, wear powder generated by the sliding operation with the wall part 210 defining a first groove part 303 drops in the first groove part 303 provided in the longitudinal direction of a sliding part 302, namely in the direction along the rotating orbit 301 of the load tab 107.

The load tab 107 reaches the first guide part 203 after passing the outgoing part 207 through the sliding operation, and the magnetic head slider 106 is then moored at a predetermined position.

On the other hand, when the load operation is started, the load tab 107 is loaded on the storage medium 101 passing the reverse route from that for the unloading operation. Namely, the load tab 107 is loaded on the storage medium 101 by moving toward the 305 side from the 306 side on the rotating orbit 301 which is almost parallel to the first groove part 303.

In this case, the side wall 210 defining the first groove part 303 is not configured as a projected part to impede operation of the load tab 107 during the sliding operation because the first groove part 303 is formed almost parallel to the rotating orbit 301 during the sliding operation of the load tab 107.

In this example, a groove part formed along a preset arc is used as the ramp mechanism of the above arced shape aligning with the orbit 301 of the load tab 107. However, the invention is not limited only to the above shape, and it is enough when the groove part is almost parallel to the sliding orbit of the load tab 107 indicated as the orbit 301.

Even when the ramp mechanism is provided with the groove part parallel to the longitudinal direction thereof, and the rectangular ramp mechanism has a longitudinal dimension in the sliding direction of the load tab 107, the orbit 301 of the load tab is still likely to cross the groove part 210 to some extent. However, the present invention can still be applied because such ramp mechanism does not present a wall part which obstructs the load tab 107.

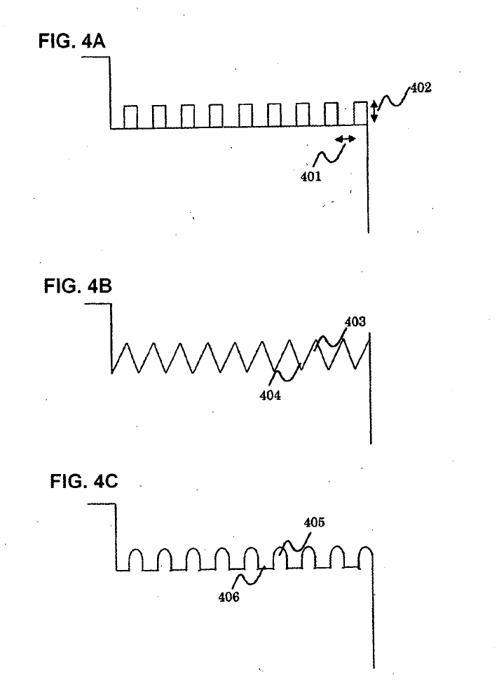

Here, the cross-sectional shape of the first groove part 208 used in this embodiment is adequate when it has the rectangular or trapezoidal shape shown in FIG. 2C and FIG. 4A. A suitable width 401 is about 0.2 mm and a suitable depth 402 is about 0.5 mm. In regard to the number of grooves and an interval between the grooves, suitable values may be determined depending on the shape of the ramp and the load tab.

Generation of wear powder can be further reduced by forming the tops 224 of the side walls 210 to have the sharp end-point structure shown in FIG. 4B. If the tops 224 have the sharp end-point cross-section, the top surface is no longer flat and it has an inclination angle toward the grooves. Accordingly, wear powder generated by the sliding operation does not stay at the top surfaces of the wall parts but drops into the groove parts 404. Therefore, wear powder can be accumulated easily within the grooves 404.

When the cross-sectional shape of the top surface of the side wall 210 defining the first groove part 208 is changed to a semi-circular shape 405 as shown in FIG. 4C, a similar effect to that of the sharp end-point structure can be attained because the sliding area with the load tab 107 can also be reduced as in the case of the sharp end-point structure, and wear powder generated can be accumulated in the groove parts 406.

Therefore, according to one aspect of the first embodiment of the present invention, a projected part that impedes operation of the load tab 107 during the sliding operation is no longer needed by forming the first groove part 303 along the rotating orbit 301. In this manner, generation of unwanted resistance between the load tab 107 and the sliding part 302 can be controlled during the loading/unloading operations. Therefore, power consumption of the magnetic disk drive can be lowered.

It is also possible to reduce the amount of wear powder generated because the contact area and resistance during the sliding operation can be reduced by forming the first groove part 208 to compliment the sliding part along the rotating orbit 301 of the load tab 107.

If wear powder is generated during the sliding operation, it is accumulated within the first groove part 208, and if wear powder drops in the direction of storage medium 101 from the groove part 208, such wear powder drops into the second groove part 209 provided at the end part of the first groove part, preventing the dropping thereof on the storage medium 101.

Accordingly, a head failure, namely a magnetic disk drive failure resulting from wear powder can be reduced, and influence on the system where the magnetic disk drive is used such as loss of data can also be reduced.

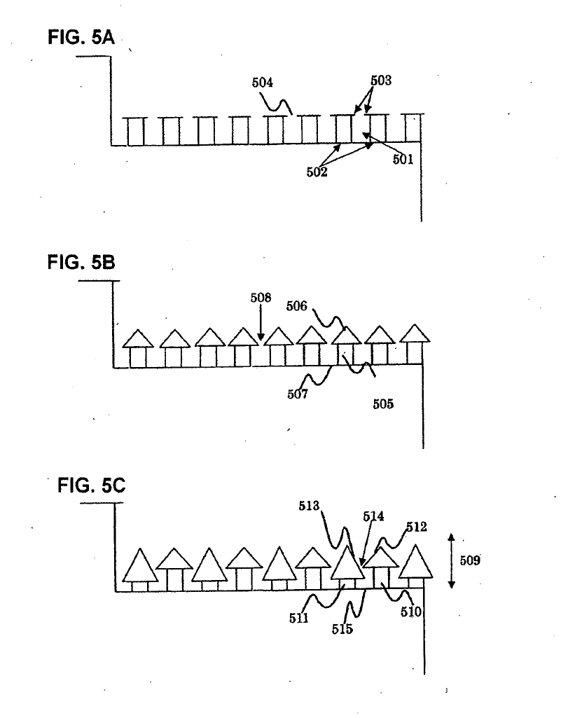

FIG. 5A-5C show cross-sectional shapes of the first groove part 208 formed in the sliding part 302 in the second embodiment.

In this second embodiment, a scatter preventing part 503 extends over a groove part 501 a predetermined length toward the center in the short-side direction of the groove part for partially covering the groove part between the top surfaces of adjacent wall parts 502 along the longitudinal direction. The scatter preventing part 503 does not cover the entire groove part 501, and the area of the scatter preventing part 503 extending from the opposing wall parts 502 allows an aperture 504 to be formed on the groove part 501. Therefore, wear powder adhered to the load tab 107 can be dropped into the groove parts 501.

For example, when the width of the groove part is set to about 0.2 mm, the aperture 504 of about 0.1 mm may be structured on the groove part 501 by setting the scatter preventing part to about 0.05 mm; thereby, wear powder can be dropped to the groove parts 504 through the apertures.

Accordingly, wear powder once dropped into the groove part 504 can be prevented from scattering into the casing because the scatter preventing part 503 works as a wall for preventing scatter of the wear powder into the casing from the groove part even when the orientation of the magnetic disk drive is changed, for example, by 90 degrees.

The scatter preventing part 506 can also be tapered narrower toward the center in the short-side direction of the groove part 507 from the wall part 505, as shown in FIG. 5B.

With the scatter preventing part 506 tapered narrower toward the end part or top, the sliding contact area with the load tab 107 can be reduced more than that of FIG. 5A. Therefore, generation of wear powder can further be reduced. In addition, since inclination is provided toward the groove part 507, wear powder can fall easily into the groove part 507 from the upper part of the scatter preventing part 506. As a result, the aperture 508 on the groove part 507 can be narrowed, fairly trapping the wear powder in the groove parts 507, and scatter of wear powder can be prevented more effectively.

In addition, both or only one of the scatter preventing portions (512, 513) may be extended up to the opposite side exceeding the center of the short-side of the groove part 515 by setting the shape of the scatter preventing part such that the portions having the maximum width of adjacent scatter preventing portions (512, 513) as shown in FIG. 5C, are arranged at different heights 509. In this manner, the bottom part of the groove part 515 is shielded by the scatter preventing portions (512, 513), while preserving the aperture 514 for dropping wear powder into the groove part 515.

Accordingly, generated wear powder slides over the sloping area toward the groove parts 515 of the scatter preventing portions (512, 513), easily dropping into the groove parts 515 through the apertures 514 for accumulation therein. Moreover, scatter of wear powder can be better prevented even when the orientation of the magnetic disk drive is changed by 180 degrees.

It is also possible to provide the scatter preventing part on the groove 209 for preventing dropping of wear powder from the end part of the first groove part 208. It is sufficient, though, when the scatter preventing part explained above is provided along the longitudinal direction of the groove part to prevent dropping of wear powder. As explained above, scatter of wear powder can be reduced effectively by utilizing the scatter preventing part on each groove part as required.

Therefore, according to an aspect of the second embodiment, if wear powder which is once dropped into the groove part scatters within the casing from the groove part due to an external factor such as a change in orientation of the device or vibration thereof, scatter of wear powder from the groove part due to contact thereof with the scatter preventing part can be reduced or prevented. Accordingly, a head failure, namely a premature magnetic disk drive failure due to drop of wear powder on the storage medium can be prevented.

According to one of the advantages of the present invention, resistance from a sliding surface generated by the sliding operation of the head slider can be reduced because a projected part is not provided for wear powder accumulation, and therefore power consumption of the magnetic disk drive can be reduced.

Moreover, according to another advantage of the present invention, it is possible to prevent scatter of wear powder into the casing due to the usage condition of the device and other external factors, etc., and a premature head failure can also be prevented by reducing generation of wear powder through reduction of resistance and contact area in the sliding operation and also by providing a scatter preventing means. As a result, influence on the operation of a system due to loss of data can be reduced or eliminated.

While the principles of the invention have been described above in connection with specific apparatus and applications, it is to be understood that this description is made only by way of example and not as a limitation on the scope of the invention.

What is claimed is:

1. A ramp mechanism for holding a head suspension having a head slider in a predetermined position outside the area of a storage medium comprising:
an entry part disposed at one side of said ramp mechanism;
a mooring part disposed at another side of said ramp mechanism; and
a sliding part between said entry part and said mooring part, said sliding part having a first groove part with at least one groove provided along a longitudinal direction thereof.

2. The ramp mechanism according to claim 1 comprising a second groove part provided along a lateral direction of said sliding part.

3. The ramp mechanism according to claim 1, wherein said first groove part is provided almost in parallel to a sliding direction of the head suspension

4. The ramp mechanism according to claim 1, comprising a plurality of adjacent grooves spaced from each other by wall parts having a top, the grooves having opposed side walls.

5. The ramp mechanism according to claim 4, wherein the tops of the wall parts are flat.

6. The ramp mechanism according to claim 4, wherein the tops of the wall parts have a sharp end point

7. The ramp mechanism according to claim 4, wherein the tops of the wall parts have a semi circular shape.

8. The ramp mechanism according to claim 4, wherein a scatter preventing part extends a predetermined distance toward a center in the short-side direction of the grooves from the tops of the wall parts.

9. The ramp mechanism according to claim 8, wherein the scattering preventing parts have a flat surface.

10. The ramp mechanism according to claim 8, wherein the top surfaces of the scatter preventing parts have a sharp end point.

11. The ramp mechanism according to claim 8, wherein adjacent scatter preventing parts extending over the grooves are located at different heights.

12. A storage device for storing data comprising:
a head slider having a head to access a storage medium;
a suspension for supporting the head slider;
an actuator coupled with the suspension to move the head slider to a predetermined position; and
a ramp mechanism having,
an entry part disposed at one side of said ramp mechanism,
a mooring part disposed at another side of said ramp mechanism; and
a sliding part between said entry part and said mooring part, said sliding part having a first groove part with at least one groove provided along a longitudinal direction thereof.

13. The storage device according to claim 12 comprising a second groove part provided along a lateral direction of said sliding part.

14. The storage device according to claim 12, wherein said first groove part is provided almost in parallel to a sliding direction of the head suspension.

15. The storage device according to claim 12, comprising a plurality of adjacent grooves spaced from each other by wall parts having a top, the grooves having opposed side walls.

16. The storage device according to claim 15, wherein the tops of the wall parts are flat.

17. The storage device according to claim 15, wherein the tops of the wall parts have a sharp end point.

18. The storage device according to claim 15, wherein the tops of the wall parts have a semi circular shape.

19. The storage device according to claim 15, wherein a scatter preventing part extends a predetermined distance toward a center in the short-side direction of the grooves from the tops of the wall parts.

20. The storage device according to claim 19, wherein the scattering preventing parts have a flat surface.

21. The storage device according to claim 19, wherein the top surfaces of the scatter preventing parts have a sharp end point.

22. The storage device according to claim 19, wherein adjacent scatter preventing parts extending over the grooves are located at different heights.
